(19) United States
(12) Patent Application Publication
(10) Pub. No.: US 2015/0278410 A1
(43) Pub. Date: Oct. 1, 2015

(54) METHOD FOR MONITORING SYSTEM VARIABLES OF A DISTRIBUTION OR TRANSMISSION GRID

(71) Applicant: ABB TECHNOLOGY AG, Zurich (CH)

(72) Inventors: Jha Rajeev KUMAR, Aachen (DE); Albert MOSER, Aachen (DE); Jochen KREUSEL, Mannheim (DE)

(73) Assignee: ABB TECHNOLOGY AG, Zurich (CH)

(21) Appl. No.: 14/672,725

(22) Filed: Mar. 30, 2015

(30) Foreign Application Priority Data
Apr. 1, 2014 (EP) 14 163 004.6

(51) Int. Cl. G06F 17/50; G06F 17/18

(52) U.S. Cl. CPC G06F 17/5009; G06F 17/18

(57) ABSTRACT

A method for monitoring system variables of an energy distribution or transmission grid includes measuring at least one of the system variables of a system variable vector, estimating the system variables using system equations reflecting a dynamic and static behavior of the system variables on the grid, and displaying the estimated system variables on a screen. To improve the accuracy of the estimated system variables, maximum log-likelihood estimates of the system variables are determined based on minimizing an objective function which includes a probability density function of the corresponding measurement error for each of the system variables for which measurements are taken. The objective function also includes system equations having as the system variable vector at least all of the system variables for which measurements are taken, and for at least one parameter of the state equations a corresponding predefined range of parameter values expressed as a parameter uncertainty.

### RELATED APPLICATION(S)

This application claims priority under 35 U.S.C. §119 to European application 14163004.6 filed on Apr. 1, 2014, the entire content of which is hereby incorporated by reference.

### FIELD

The disclosure relates to a method for monitoring a state of an energy distribution or transmission grid by monitoring system variables, wherein the system variables are estimated based on system equations reflecting the dynamic or static interdependency of the system variables of the grid and based on measurements taken for at least one of the system variables, and wherein the estimated system variables are visualized on a screen.

### BACKGROUND INFORMATION

A transmission grid is commonly used to transport commodities such as electricity, gas, oil, or water over long distances, from a location where the respective commodity is produced, to a distribution station which is located in the vicinity of respective consumers. From the distribution station, a corresponding distribution grid transports the commodity further to its various final destinations. Electricity, gas, and oil are pure energy sources, while water is used in a much wider way. Even so, all four commodities will in the following be summarized under the term energy source or simply energy.

During the past years, energy transmission and distribution, such as for electricity, has become more complex due to an increased spatial distribution of production sites and due to a more intermittent energy production, depending on the availability of for example renewable energy. Further, more and more actively controllable loads are introduced which can result in a high occurrence of simultaneous load reactions to a specified grid state. In addition, the energy demand is increasing worldwide, putting more pressure to grid operators to increase the efficiency of their respective grids. One of the ways to increase the efficiency is to increase the grid utilization factor, for example the relation between the total energy available and the energy demanded by the users, and to reduce the operating margins in the ratings of the technical equipment belonging to the grid.

The reduction of margins implies that the grid is going to be operated closer to its limits, and that the likelihood for it to hit these limits is going to be increased. Hence it is of utmost importance for a grid operator to be aware of the state of the grid in order to carry out remedial actions in time for avoiding a critical state, such as contingency analysis, load-shedding, or issuing of a request for immediate service or provision of additional energy from a different production site.

In order for the operator to get information on the current state of the grid, the obvious solution is to use online measurements which shall be presented to the operators in close to real-time. However, these close to real-time measurements can be available at a comparatively large quantity in transmission grids, but in distribution grids they are not so common. In order to obtain the actual values of further system variables of the grid than available from measurements, it is known to apply state estimation techniques using available online measurements and guessed measurements, also called pseudo measurements, with the help of historical information based on system equations of the grid and certain statistical assumptions on measurement errors.

The term system variable refers to any time-varying or static variable describing the dynamic or static physical behavior of the energy source in the respective grid, e.g. for electricity this includes voltage, current, real power and reactive power; for fluids this includes temperature, pressure, volume and flow rate. Multiple system variables taken together can form a system state vector, also called grid state or system state. The values of the system variables are not known in advance, and the goal of the method presented here is to estimate the values of the system variables.

The term system equation refers to time-dependent or static equations which reflect the relation between different system variables. Accordingly, a set of system equations formulated for system variables of a grid forms a mathematical model of the dynamic and static behavior of the grid, also called grid model.

In addition to the problem of missing measurements for certain system variables, another issue can arise from the fact that measurements should be telemetered (e.g. transmitted), due to the spatial distribution of the respective grid equipment. The measurements are telemetered to a grid control system where they are then processed and visualized in a control room, for example at the operator's working place. Telemetry always includes a certain time delay and, more importantly, a certain risk for data transmission losses, so that the measurement data actually arriving in the control room cannot be assumed to be completely error-free. Accordingly, these measurements cannot be relied upon when taking operational decisions in a grid system with equipment having low marginal capacity. To deal with this latter problem, one of the existing ways is not to believe the measurement value as it is, but again to apply state estimation techniques for estimating a corresponding grid system variable which is close to the measurement and yet satisfies the fundamental grid equations, such as in the case of electricity Kirchoff's Voltage Law and Current Law.

In Kong et al.: “Advanced load modelling techniques for state estimation on distribution networks with multiple distributed generators”, PSCC 2011, Stockholm, a method is presented for obtaining pseudo-measurements on the load side of an electricity distribution network to use in the well-known weighted least square based state estimation technique. The least square based state estimation minimizes the square of a measurement error vector. Inputs to the state estimation are the measurement values and the modeled variance of the measurements. For modeling the pseudo-measurements, for example the real and reactive load side power for which no measurements are available, probability density functions are determined from historical load data, using four different approaches: the method of assumed variance, the normal distribution fitting, the Gaussian Mixture Modelling and the correlation method. In order to be able to use the weighted least square estimator, which assumes a normal measurement error distribution, for example a Gaussian error distribution, for each of the probability density functions at least one variance is determined.

Further, Kong describes that so called equality constraints are taken into account by using Lagrange multiplier vectors. In general, equality constraints are known constraints in the physical behavior of some of the system variables which can be expressed by an equation. For example, in those grid nodes or grid buses where neither generators nor loads are connected, the corresponding sum of system variables for real and reactive power flowing into the node should at all times equal to zero. The system variables that are estimated in Kong are voltage magnitudes, voltage phase angles, real power and reactive power flow between different buses.

From Handschin et al.: “An interior point method for state estimation with current magnitude measurements and inequality constraints”, PICA 1995, Salt Lake City, a state estimation algorithm is known which can handle current measurements in addition to power and voltage measurements and which takes into account not only equality constraints, but inequality constraints as well. Current measurements have the disadvantage that directional information is missing so that the sign of the corresponding real power and/or reactive power cannot be determined. By using inequality constraints, for example where the given constraints on the physical behavior of some of the system variables is expressed by corresponding inequalities, the missing directional information can be added to the state estimation. The criterion to be minimized in Handschin by the state estimation algorithm is again a weighted least square criterion.

The inventors have now realized that the widely used weighted least square (WLS) algorithms are commonly based on certain assumptions which are not valid in today's distribution grids or networks, considering low voltage grids. Hence, these assumptions can worsen the overall estimation accuracy. Some of the assumptions which cannot be valid in the context of state estimation for a distribution network are the assumptions that measurements have a Gaussian error distribution, power in the grid branches has a unidirectional flow since the distribution grid is operated radially or since in a low voltage grid, active power generally flows from a centralized conventional power generator to the load side.

The latter of these assumptions leads to the possibility for Handschin to explicitly determine the direction to a given current measurement before using it in the weighted least square state estimation formulation. However, in today's electricity distribution grids, power can flow in a bi-directional way since low voltage power generators, belonging to photovoltaic installations, are included in the grids. For bidirectional power flow, the predetermined current direction can be incorrect.

### SUMMARY

An exemplary method for monitoring system variables of an energy distribution or transmission grid is disclosed, comprising: defining a system variable vector containing multiple system variables of the grid; measuring at least one of the system variables of the system variable vector; estimating the system variables of the system variable vector by using system equations reflecting a dynamic and static behavior of the grid, and displaying the estimated system variables on a screen, wherein the system variables of the system variable vector are estimated by determining their maximum log-likelihood estimates based on minimizing an objective function, wherein the objective function includes the system equations which include, as the system variable vector, at least all of the at least one system variables for which measurements are taken, and wherein the objective function includes a probability density function of a corresponding measurement error for each of the at least one system variables for which measurements are taken.

### BRIEF DESCRIPTION OF THE DRAWINGS

The disclosure and its exemplary embodiments will become even more apparent from the example and its exemplary embodiments described below in connection with the appended drawings in which:

FIG. 1 illustrates a line diagram for a part of an electrical MV and LV distribution grid according to an exemplary embodiment of the present disclosure;

FIG. 2 is an illustration of the lumped pi model for electrical series devices according to an exemplary embodiment of the present disclosure;

FIG. 3 is an illustration of parameter uncertainty according to an exemplary embodiment of the present disclosure;

FIG. 4 illustrates a Gaussian and a lognormal probability density function according to an exemplary embodiment of the present disclosure; and

FIG. 5 illustrates the display of values of the grid state variables on a screen according to an exemplary embodiment of the present disclosure.

### DETAILED DESCRIPTION

Exemplary embodiments of the present disclosure to provide a method for monitoring system variables of a distribution or transmission grid which is not based on the above listed assumptions but takes into account given conditions in today's electric power distribution grids.

Exemplary embodiments disclosed herein provide a method as explained in the introduction, wherein the system variables are estimated by determining maximum log-likelihood estimates of the system variables based on minimizing an objective function which contains the system equations which take into account as system variables to be estimated at least all system variables for which corresponding measurements are available, for each of the system variables for which measurements are taken, a probability density function of the corresponding measurement error.

An exemplary method of the present disclosure does not use a weighted least square based state estimation technique, which is always based on the assumption that measurement errors have a Gaussian error distribution. Instead, the objective function to be minimized contains a term where the probability density function of measurement error can be entered directly for each of the measurements, for example each of the measured system variables. As a result, any form or type of probability density function for the measurement errors is considered in the state estimation, including both Gaussian and non-Gaussian error distributions. The exemplary method can be useful for modeling the measurement errors in connection with measurements or pseudo-measurements of electrical medium-voltage and low-voltage loads, since analysis of historical data has revealed that their error distribution appears to fit more to either a beta error distribution or a lognormal error distribution.

Another exemplary embodiment of the present disclosure involves the direct integration of all available measurements in the proposed method, for example the unknown system variable vector includes not only voltage magnitude and phase angle as in known approaches, but allows for integrating all measured variables. Hence, the method directly estimates the measured variables, whereas known approaches first estimate the voltage magnitudes and phase angles at all buses and then calculate other system variables from the estimated results of voltages and angles. According to an exemplary method of the present disclosure, the bus voltages and phase angles are not the only unknown system variables to be estimated, as in known state estimation methods. The exemplary method described herein provides for directly integrating any measured variable into the vector of unknown system variables. This helps for example in modelling current magnitude measurements in case of bi-directional power flow, so that no current direction needs to be determined beforehand, but is output of the state estimation.

According to an exemplary embodiment of the present disclosure, the objective function to be minimized contains a term containing the probability density functions of the measurement errors and at least one further term which contains the system equations. It is to be noted that the term with the probability density functions does not contain any system equations, for example it is free of any grid model. Instead, it consists only of a statistical modeling of the measurement errors. Opposed to that, in the existing approaches, such as in the weighted least square estimation, the statistical model and the grid model are mixed. Due to the proposed separation of statistical model and grid model which becomes possible due to the integration of all measured system variables in the system variable vector to be estimated, it is now much easier to integrate the findings from statistical research on the true distribution of measurement errors in a specified grid, since the grid model remains unaffected of any changes in this respect.

By using the proposed method, the accuracy of the state estimation results is considerably improved over the known weighted least square estimation methods. This can be due to the fact that knowledge is used which is obtained from historical data on measurement error distributions. This knowledge is introduced in a maximum log-likelihood formulation of the estimation problem. The weighted least square estimation defines the minimization problem to be solved as finding the values for the system variables, for example the grid state at a certain point in time, which best correspond to the measurements taken at that certain point in time, for example for which the measurement errors could be minimum. Opposed to that, the proposed maximum log-likelihood estimation problem is formulated to find the grid state at a certain point in time which could most likely have produced the available measurements for that certain point in time, considering a given probability density function of measurement errors, a given range of some or all of the system variables and a given uncertainty of system equation parameters.

Another assumption that is made when using weighted least square estimation relates to the grid parameters. It is assumed that the parameters of the grid equipment, e.g., in case of an electricity grid the parameters resistance, inductance and capacitance, are constant and accurately known. However, it has been recognized that this supposition is not true, since grid parameters can vary over time.

According to another exemplary embodiment, the system equations can take into account for at least one parameter of the system equations a corresponding predefined range of parameter values expressed as a parameter uncertainty.

Accordingly, the uncertainties can be specified explicitly thereby defining a value range for each of the uncertain parameters. In this way, temporary changes of the parameter values are taken into account, which can be due to changes in environmental conditions, such as temperature, humidity or pressure, or due to aging of the grid equipment, or even due to operational uncertainties, such as an unknown exact tap position of a transformer tap changer. The explicit consideration of parameter uncertainties results in an further increased accuracy of the state estimation.

According to yet another exemplary embodiment of the present disclosure, the system equations can take into account for at least one of the system variables a corresponding upper and/or lower value limit expressed by way of an inequality constraint. In this way the operating range or limits for the system variables are considered during the grid state estimation, leading to even more accurate results. The inequalities allow more information to be passed to the state estimation, for example it can be defined that the bus voltages should be within 90-110% of their nominal value.

When the above approaches are combined in one and the same objective function to be minimized, as much knowledge on the behavior of the grid as is possible could be used directly for the state estimation, for example knowledge obtained from historical data or experience on measurement error distributions, on parameter uncertainties and on limits or constraints of state variables.

Advantageously, the system equations can further contain correlation relations between at least two of the system variables. In the known grid state estimation methods, it is assumed that measurements are independent from one another. However, this is not always correct. With the proposed method, it becomes now possible to take into account dependencies between measurements, for example between their corresponding system variables, as well as correlations among unmeasured system variables and between measured and unmeasured system variables. Accordingly, the correlation relations form an additional piece of knowledge which is introduced into the state estimation formulation, leading to even more correct estimation results.

This additional piece of knowledge can for example be applied in the following way. The system equations can take into account at least one measured system variable of at least one energy generator or load and the maximum log-likelihood estimates of system variables of further energy generators or loads are determined based on correlation relations to the at least one measured system variable. In this way, it becomes possible to introduce a system variable for each of the energy generators or loads, respectively, even if power is measured only once per grid node, which is often the case. In previous grid state estimation solutions, it was assumed that power was injected to or drawn from the grid only once per node. As a result, if both a generator and a load or if multiple generators and/or loads are connected to one and the same grid node, their respective power vectors were added in order to introduce the specified one resulting power vector into the state estimation. With the proposed method, the limitation of having only one power injection or consumption per node is now removed. Hence, more than one system variable can be introduced per node, up to having for each generator and load a corresponding own system variable or own set of system variables.

The objective function to be minimized by the proposed grid state estimation can be non-linear and can include in a first summand, a statistical model of the measurement errors in which the statistical model takes into account the measurements, the corresponding probability density functions, the accuracy of the measurements and the system variables to be estimated, in a second summand, the system equations which take into account the parameter uncertainties and laws of the system, in a third summand, the equations which take into account the equality and/or inequality constraints corresponding to the range or limits put on the system variables, in a fourth summand, a first logarithmic barrier function for modeling a first difference between the system variables and their corresponding upper and/or lower value limit, and in a fifth summand, a second logarithmic barrier function for modeling a second difference between the actual grid parameters and their corresponding range boundaries.

In the context of the present disclosure, the second term or second summand includes the system equations only and is free from measurements. In general, measurements cannot be assumed to be error free. Hence, writing the system equations to involve measurements could not be accurate. Instead in this method, the system equations are written in terms of system variables using uncertainty in parameters, which is the more accurate and better way to represent system laws.

The second and third summands of the objective function can be multiplied by corresponding Lagrange multipliers. Lagrange multipliers are a known concept for solving a constrained maximization or minimization problem.

The objective function to be minimized can accordingly be of the form J=−ln(ƒ(z,x,R))−λₕ·h(x,w_{∈},∈)−λₓ·g(x,wₗ,l)−μ·ln(w_{∈})−μ·ln(wₗ), with

f(z,x,R) being a vector of probability density functions of measurement errors for the measurements z;

h(x, w∈, ∈) being a set of nodal and branch system equations including correlation relations, the system equations depending on x as the system variable vector and we as a variable vector for uncertainty, with ∈ standing for predetermined uncertainty parameters;

g(x, wl, l) being a set of functions which depends on the system variables x and on a variable vector wl for state variable limits l converted into constraints;

λh, λx being Lagrange multipliers;

μ being a barrier term multiplier and

In standing for log-natural.

The objective function of the exemplary method of the present disclosure is minimized, for example the maximum log-likelihood estimates are determined by a data processing unit by applying a pure Newton iteration using Jacobian and Hessian matrices.

The exemplary method can be applied to any type of energy transmission or distribution grid, such as to grids for transmitting or distributing electricity, gas, oil or water.

For an electricity grid, the unknown system variables can include at least voltage amplitudes and voltage phase angles at all grid nodes, at least one real and reactive power injection at all grid nodes which have at least one physical generator or load connected as well as real and reactive power flow in grid branches which are measured.

According to another exemplary embodiment described herein, the unknown system variables can further include branch currents. By including currents in the system variable vector, it becomes possible to provide a directly estimated solution also for those grid branches where no real or reactive power is measured. This is mostly the case in medium voltage or low voltage grids, opposed to power transmission grids where a considerable number of measurements are available for both real and reactive power.

For other grid types, the system variables can include pressure, temperature, volume, flow rate etc.

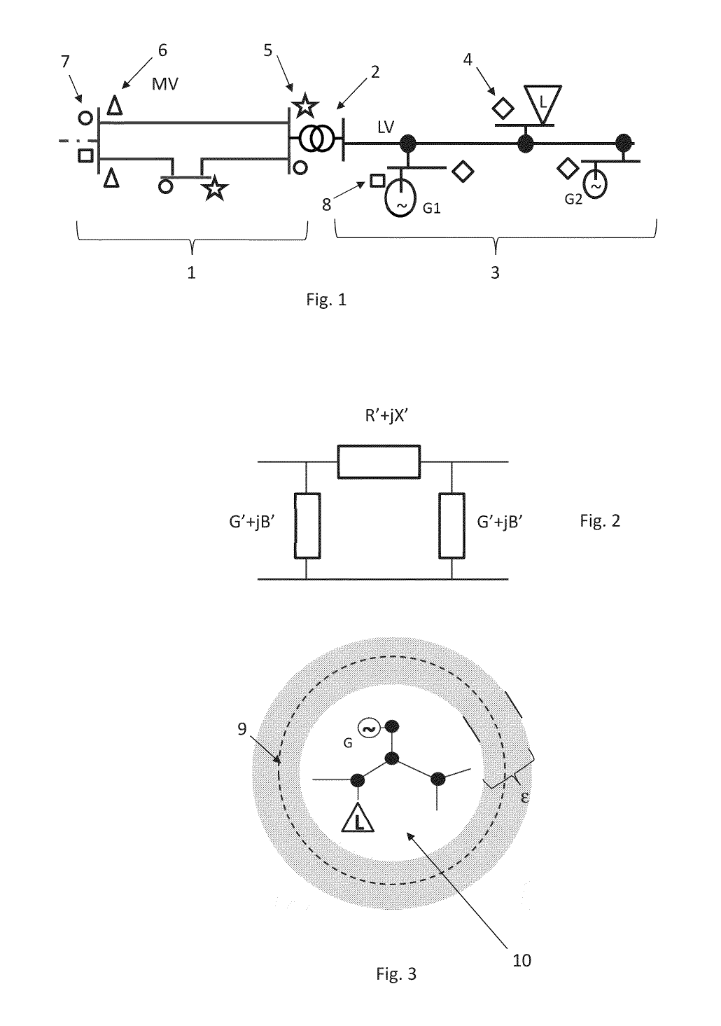

FIG. 1 illustrates a line diagram for a part of an electrical MV and LV distribution grid according to an exemplary embodiment of the present disclosure. FIG. 1 shows a line diagram illustrating a part of a medium voltage (MV) distribution grid 1 which is connected via a transformer station 2 to a low voltage (LV) distribution grid 3. In the diagram, available measurements of some of the system variables of the MV or LV grid, respectively, are shown, each measured variable being identified by a different symbol. Current magnitude measurements 6 are indicated by a triangle; voltage amplitude measurements 7 are indicated by a circle; real and/or reactive power measurements 8 in connection with power generation, are referenced by a rectangle; real and/or reactive power measurements 5 in connection with power loads or power consumption, are illustrated by a star. With the diamond symbol, it is indicated for which busses a historical load profile 4 is available.

According to an exemplary embodiment of the present disclosure and in order to evaluate the state of the whole distribution grid, it could be advantageous for an operator to be able to get information on all interesting state variables of the grid, for example information on at least real and reactive power in all branches and voltage amplitude and phase angle at all nodes. However, as can be seen from FIG. 1, not all of these system variables are always measured and correctly known. Instead, for some branches current magnitude measurements are provided, and on the LV side, historical load profiles can be used as a source of information.

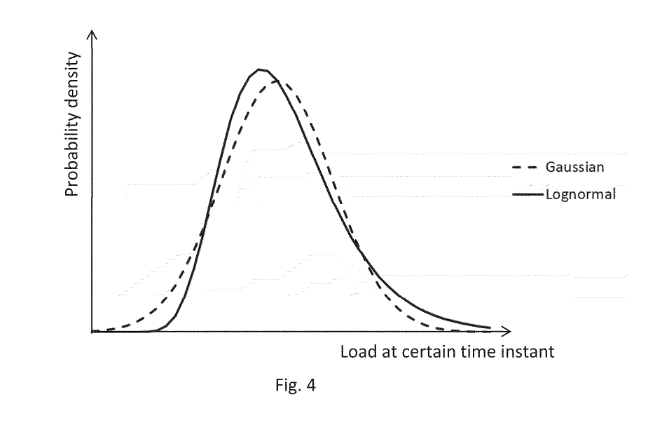

Starting from the available measurements and historical data profiles, in this example load profiles, the missing system variables can be determined by applying a state estimation technique which directly takes into account probability density functions of measurement errors. Measurement errors associated with telemetered (e.g., transmitted) data are assumed to be distributed normally (Gaussian). However, the historical data profiles which form the basis for determining the probability density functions associated with pseudo measurements, can in fact be of any type, Gaussian or non-Gaussian. FIG. 4 illustrates a Gaussian and a lognormal probability density function according to an exemplary embodiment of the present disclosure. In the example of FIG. 4, the distribution of the values for a LV load, for example LV power consumption, is shown with the corresponding probability density for each value, wherein the continuous line illustrates a log-normal distribution of the probability density, and the dashed line shows a Gaussian distribution. Recent research has revealed that LV loads fit more to the log-normal distribution than the Gaussian.

In the known weighted least square state estimation techniques, such non-Gaussian error distributions cannot be considered. This drawback is overcome with the proposed method, so that the estimation errors for state variables with a non-Gaussian measurement error distribution can be reduced.

FIG. 2 is an illustration of the lumped pi model for electrical series devices according to an exemplary embodiment of the present disclosure. In order to estimate system variables using a state estimation technique, a grid model is specified. The parameters of the grid model can be determined by applying the lumped element model technique to the devices and equipment of the grid. For an electrical grid, the lumped PI model as shown in FIG. 2 can be developed for series devices, e.g., lines and transformers. The line parameters accordingly become distributed resistance R′ expressed in Ohms per unit length; distributed inductance X′ expressed in Henries per unit length; distributed conductance G′ of the dielectric material separating two line conductors and between conductor and earth, represented by a shunt resistor and expressed in Siemens per unit length; and the distributed capacitance B′ between the two line conductors and between conductor and earth expressed in Farads per unit length.

FIG. 3 is an illustration of parameter uncertainty according to an exemplary embodiment of the present disclosure. As shown in FIG. 3, for an example grid with one load L and one generator G, these line parameters are not known exactly, as indicated by a grey colored band of width ∈, having a dashed circle 9 in the middle. The dashed circle 9 stands for the correctly known parameter values and ∈ represents a vector of uncertainties corresponding to the parameters.

In other words, the resistance R′ of FIG. 2 is only known as R′=R_{corr}′±ΔR′, with R′corr being the correct resistance value and ΔR′ being the corresponding uncertainty ∈_R.

For the whole grid, the parameter uncertainty can be expressed as |C(π)|≦∈.

In addition to taking into account the parameter uncertainties, limits to the system variables can be considered by the state estimation as well. The limits for a system variable vector x can be expressed as LL≦x≦UL, with LL being the lower limit vector and UL being the upper limit vector.

In order to be introduced into the state estimation method, the limits are converted into constraints using an additional pair of variables, resulting in x−w×L=LL and x+w×U=UL with w×L, w×U≧0.

This is done for each system variable having a limit and for each system equation with a parameter having an uncertainty, so that a vector wl is obtained for all the limits and a vector we for all the uncertainties.

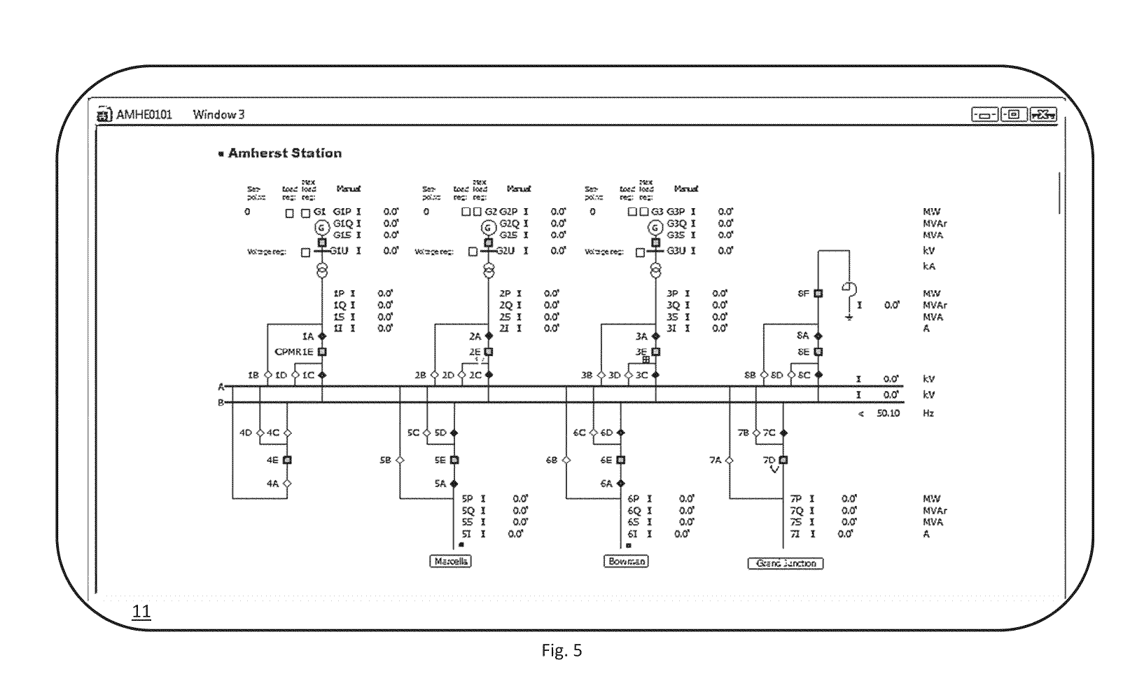

FIG. 5 illustrates the display of values of the grid state variables on a screen according to an exemplary embodiment of the present disclosure. Once the probability density functions for the measurement errors and the grid model including the system variable limits and the parameter uncertainties are obtained, they are used together with measurements taken at a certain point in time in an objective function, where the objective function is to be minimized by a maximum log-likelihood algorithm. As a result, the system variables of the grid model are estimated for the certain point in time and are visualized on a screen 11, as illustrated for example by FIG. 5.

The screen can be located in a control room of a grid monitoring system and the exemplary method described herein is executed on a data processing device which receives the measurements via telemetry and either belongs to that control room and transmits the estimated results of system variables to be monitored directly to the screen, or is located outside the control room and transmits the results to that control room.

The state estimation method can be extended by further taking into account correlations between at least two of the system variables. In FIG. 1, two generators G1 and G2 are shown, where real and reactive power measurements are only taken for the first of the two generators, G1. By using correlation techniques, the value of the variables corresponding to real and reactive power of generator G2 can be directly estimated, wherein the correlation relations are modeled in the set of system equations h(x, w∈, ∈).

According to exemplary embodiments of the present disclosure the system can include one or more of any known general purpose processor or integrated circuit such as a central processing unit (CPU), microprocessor, field programmable gate array (FPGA), Application Specific Integrated Circuit (ASIC), or other suitable programmable processing or computing device or circuit as desired. The general processor(s) can be configured to include and perform features of the exemplary embodiments of the present disclosure such as, method for monitoring system variables of an energy distribution or transmission grid, and thereby function as a special and unique processor. The features can be performed through program code encoded or recorded on the processor(s), or stored in a non-volatile memory device, such as Read-Only Memory (ROM), erasable programmable read-only memory (EPROM), or other suitable memory device or circuit as desired. In another exemplary embodiment, the program code can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

Thus, it will be appreciated by those skilled in the art that the present invention can be embodied in other specific forms without departing from the spirit or essential characteristics thereof. The presently disclosed exemplary embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for monitoring system variables of an energy distribution or transmission grid, comprising:
defining a system variable vector containing multiple system variables of the grid;
measuring at least one of the system variables of the system variable vector;
estimating the system variables of the system variable vector by using system equations reflecting a dynamic and static behavior of the grid, and
displaying the estimated system variables on a screen,
wherein the system variables of the system variable vector are estimated by determining their maximum log-likelihood estimates based on minimizing an objective function,
wherein the objective function includes the system equations which include, as the system variable vector, at least all of the at least one system variables for which measurements are taken, and
wherein the objective function includes a probability density function of a corresponding measurement error for each of the at least one system variables for which measurements are taken.

2. The method according to claim 1, wherein the system equations further include for at least one parameter of the system equations a corresponding predefined range of parameter values expressed as a parameter uncertainty.

3. The method according to claim 1, wherein the system equations further include for at least one of the system variables of the system variable vector at least one of a corresponding upper and lower value limit expressed by way of an inequality constraint.

4. The method according to claim 1, wherein the system equations contain correlation relations between at least two of the system variables of the system variable vector.

5. The method according to claim 4, wherein the system equations include at least one measured system variable of at least one energy generator or load, and wherein the maximum log-likelihood estimates of system variables of further energy generators or loads are determined based on correlation relations to the at least one measured system variable.

6. The method according to claim 1, wherein the system equations contain at least one system variable for each physical location where energy is injected to or drawn from the grid.

7. The method according to claim 1, wherein the probability density functions of measurement errors are of non-Gaussian type or of Gaussian type.

8. The method according to claim 1, wherein the objective function to be minimized is non-linear and comprises:
in a first summand, a statistical model of measurement errors where the statistical model includes the system variable measurements, corresponding probability density functions, a function of accuracy of the measurements, and the system variables to be estimated;
in a second summand, state equations which include parameter uncertainties;
in a third summand, the state equations which take into account the equality and/or inequality constraints corresponding to a range/limit on system variable;
in a fourth summand, a first logarithmic barrier function for modeling a first difference between actual system variables and corresponding upper and/or lower value limit; and
in a fifth summand, a second logarithmic barrier function (μ·ln(w_{∈})) for modeling a second difference between actual grid parameters and corresponding range boundaries.

9. The method according to claim 8, wherein the second and third summands are multiplied by corresponding Lagrange multipliers (λh, λx).

10. The method according to claim 1, wherein the maximum log-likelihood estimates are determined by applying a pure Newton iteration using Jacobian and Hessian matrices.

11. The method according to claim 1, wherein the grid is an electricity grid and the system variables to be estimated contain voltage amplitudes and voltage phase angles at all grid nodes, at least one real and reactive power injection at all grid nodes which have at least one physical generator or load connected as well as real and reactive power flow in grid branches which are measured.

12. The method according to claim 11, wherein the system variables further contain branch currents.

13. The method according to claim 1, wherein together with the estimated system variables other variables calculated based on the results of the system variables are visualized on the screen.
